(19) United States
(12) Patent Application Publication
(10) Pub. No.: US 2012/0050248 A1
(43) Pub. Date: Mar. 1, 2012

(54) Driving Method for Active-Matrix Bistable Liquid Crystal Display

(75) Inventors: Chih-Jen Chen, Yongkang City (TW); Ming-Hua Hsieh, Taipei County (TW)

(73) Assignee: INDUSTRIAL TECHNOLOGY RESEARCH INSTITUTE, Hsinchu (TW)

(21) Appl. No.: 12/970,063

(22) Filed: Dec. 16, 2010

(30) Foreign Application Priority Data
Aug. 25, 2010 (TW) 099128378

(51) Int. Cl. G09G 5/00

(52) U.S. Cl. 345/212

(57) ABSTRACT

The disclosure provides an operating method for an active-matrix bistable liquid crystal display (LCD) in which each frame of the LCD is refreshed during a single frame time. The method includes the steps of: driving an external charge voltage to a row of pixels of the LCD; removing the external charge voltage from the row of pixels, and then the row of pixels being driven by an internal storage-capacitor voltage of the row of pixels in the following first time interval; driving an external recharge voltage to the row of pixels; removing the external recharge voltage from the row of pixels, and then the row of pixels being driven by an internal storage-capacitor voltage of the row of pixels in the following second time interval; and driving an external discharge voltage to the row of pixels.

### CROSS-REFERENCE TO RELATED APPLICATIONS

This non-provisional application claims priority under 35 U.S.C. §119(a) on Patent Application No(s). 099128378 filed in Taiwan, R.O.C. on Aug. 25, 2010, the entire contents of which are hereby incorporated by reference.

### TECHNICAL FIELD

The present disclosure relates to an operating method for an active-matrix bistable liquid crystal display (LCD).

### TECHNICAL BACKGROUND

The chiral-nametic liquid crystal (LC) is an LC material of reflectivity, which is particularly applicable to LCDs of high resolution, additive colored grayscale image, low power consumption, and low cost. This LC material has two stable states at an external electrical field of zero: the Planar state to reflect light of certain wavelengths and the Focal conic state to scatter light. When the chiral-nametic LC is subject to a voltage more than its threshold voltage, such as 30 volts, it poses a state of optical transparency after the LC is vertically aligned at the Homeotropic state. If the applied voltage in the Homeotropic state is eliminated rapidly, the LC is relaxed to the transient Planar state. The Homeotropic and transient Planar states are instable but serve as immediate states in transition of state.

Due to bistable states, color performance, low power consumption, and low cost, the chiral-nametic LCD has become promising in the display development. More particularly, the chiral-nametic LCD of active matrix is advantageous in speed of image frame refreshment and can avoid the drawback of crosstalk in its passive-matrix counterpart to gain better image performance.

A typical active-matrix LCD 10 and the pixel 130 structure thereof are schematically illustrated in FIG. 1. The pixel matrix is composed of data lines 111/112/113 and scan lines 121/122/123. Each pixel 130 is connected to a data line and a scan line of the matrix through an active switching device, which is composed of a transistor 131, a storage capacitor 132, and a parasitic LC capacitor 133. Also, the active-matrix LCD includes a common ground connected to each of the pixels. The scan lines are used to turn on or off the transistors 131, and the data lines are used to connect to the pixels through the transistors to drive the storage capacitors.

Conventionally, multi-level voltages have been used to drive pixels of the LCDs. Moreover, each frame of the LCD can be refreshed in at least two frame times. Although the active-matrix bistable chiral-nametic LCD is more advantageous than its passive-matrix counterpart, it is still in need of further improvement in the frame driving speed, VHR, and image brightness.

### TECHNICAL SUMMARY

According to one aspect of the disclosure, one embodiment discloses an operating method for an active-matrix bistable LCD in which each frame of the LCD is refreshed during a single frame time. The method includes the steps of: driving an external charge voltage to a row of pixels of the LCD; removing the external charge voltage from the row of pixels, and then the row of pixels being driven by an internal storage-capacitor voltage of the row of pixels in the following first time interval; and driving an external discharge voltage to the row of pixels. In the embodiment, the pixels of the LCD are driven in a procedure according to the pipeline concept, where a sequence of external voltages driven to the row of pixels in a periodic cycle includes: driving the external charge voltage to a first row of pixels, removing the external charge voltage from the first row of pixels, driving the external discharge voltage to a second row of pixels after a second time interval, and removing the external discharge voltage from the second row of pixels.

According to another aspect of the disclosure, another embodiment discloses an operating method for an active-matrix bistable LCD in which each frame of the LCD is refreshed during a single frame time. The method includes the steps of: driving an external charge voltage to a row of pixels of the LCD; removing the external charge voltage from the row of pixels, and then the row of pixels being driven by an internal storage-capacitor voltage of the row of pixels in the following first time interval; driving an external recharge voltage to the row of pixels; removing the external recharge voltage from the row of pixels, and then the row of pixels being driven by an internal storage-capacitor voltage of the row of pixels in the following second time interval; and driving an external discharge voltage to the row of pixels. In the embodiment, the pixels of the LCD are driven in a procedure according to the pipeline concept, where a sequence of external voltages driven to the row of pixels in a periodic cycle includes: driving the external charge voltage to a first row of pixels, removing the external charge voltage from the first row of pixels, driving the external recharge voltage to a second row of pixels after a third time interval, removing the external recharge voltage from the second row of pixels, driving the external discharge voltage to a third row of pixels after a fourth time interval, and removing the external discharge voltage from the third row of pixels.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram of a typical active-matrix LCD and the pixel structure thereof.

FIG. 2 is a timing diagram of the external driving voltages applied to the rows of pixels of the LCD according to the first embodiment.

FIGS. 3a and 3b schematic diagrams for the time dependence of capacitor voltage V_{LC} of chiral-nametic liquid crystal: (a) without recharge, (b) with recharge.

FIG. 4 is a timing diagram of the external driving voltages applied to the rows of pixels of the LCD according to the second embodiment.

### DESCRIPTION OF THE EXEMPLARY EMBODIMENTS

For further understanding and recognizing the fulfilled functions and structural characteristics of the disclosure, several exemplary embodiments cooperating with detailed description are presented as the following.

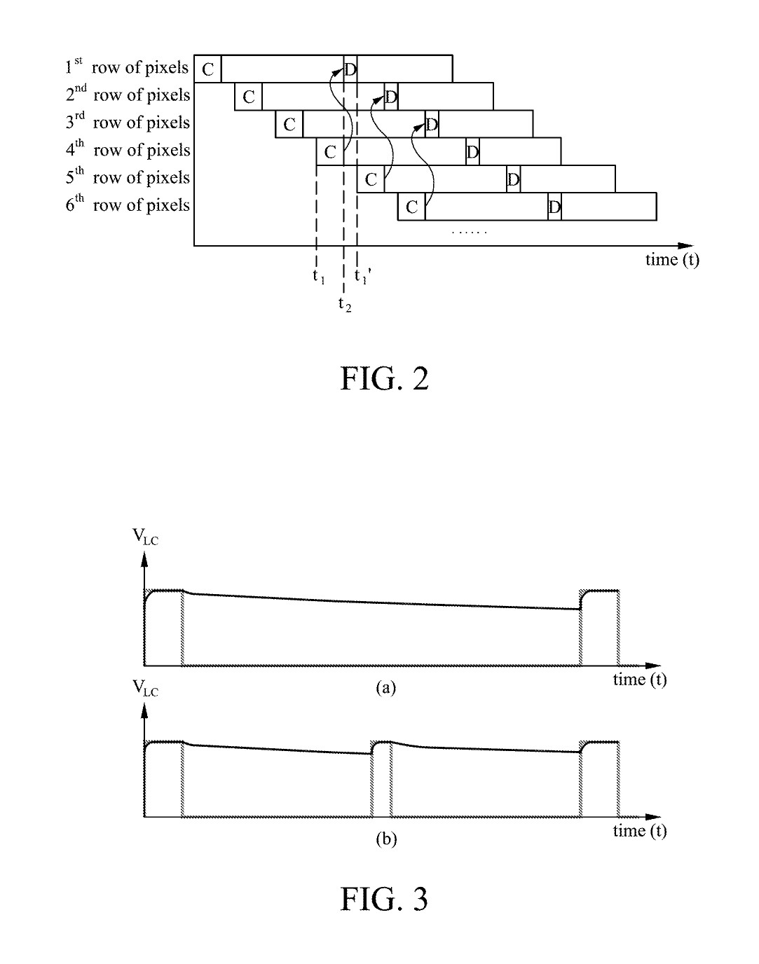

According to the present disclosure, a first embodiment provides an operating method for an active-matrix bistable chiral-nametic LCD. Please refer to FIG. 2, which is a timing diagram of the external driving voltages applied to the rows of pixels of the LCD. The driving voltages include the charge and discharge voltages, respectively denoted as C and D in FIG. 2. The operating method according the embodiment can refresh each frame of the LCD in a single frame time. The operational procedure includes: driving an external charge voltage V_{C} to a row of pixels of the LCD; removing the external charge voltage V_{C} from the row of pixels, and then the row of pixels being driven by an internal storage-capacitor voltage V_{SC} of the row of pixels in the following first time interval T₁; and driving an external discharge voltage V_{D} to the row of pixels.

The operational schedule of the driving voltages among the rows of pixels is based on the concept of pipeline. A procedure of steps according to the following exemplary embodiment is illustrated in FIG. 2. At a time of t₁, the 4th row of pixels is driven by the external charge voltage V_{C}. After a time interval of T_{C}, the external charge voltage V_{C} is removed from the 4th row of pixels at the time of t₂≧t₁+T_{C}. At the same time, the 1st row of pixels is driven by the external discharge voltage V_{D}. After a time interval of T_{D}, the external discharge voltage V_{D} is removed from the first row of pixels at the time of t₁′≧t₂+T_{D}. At the same time, the 5th row of pixels is driven by the external charge voltage V_{C}. If t₂ can be arranged to be equal to t₁+T_{C} and t₁′ can be arranged to be equal to t₂+T_{D}, the timing efficiency of the method may be maximized, but is not limited thereby. The foregoing steps are regarded as composition of a periodic cycle and repeated in the succeeding operation. Consequently, a single voltage source can provide various rows of pixels with driving the charge or discharge voltage in various times of schedule. In the embodiment, the row of pixels is driven by an internal storage-capacitor voltage of the row of pixels after the external charge or discharge voltage is removed. Further, durations of driving the external charge and discharge voltage are the same in the embodiment, but are not limited thereby, they can be different from each other.

The foregoing example can be generalized as the following to represent the pipeline operation to drive various rows of pixels. At a time of t₁, the (n)^{th} row of pixels is driven by the external charge voltage V_{C}. After a time interval of T_{C}, the external charge voltage V_{C} is removed from the (n)^{th} row of pixels at the time of t₂=t₁+T_{C}. At the same time, the (n−3)^{th} row of pixels is driven by the external discharge voltage V_{D}. After a time interval of T_{D}, the external discharge voltage V_{D} is removed from the (n−3)^{th} row of pixels at the time of t₁′=t₂+T_{D}. At the same time, the (n+1)^{th} row of pixels is driven by the external charge voltage V_{C}. The foregoing steps can be regarded as composition of a periodic cycle and repeated in the succeeding operation. In this exemplary embodiment, various rows of pixels are driven, as either charge or discharge voltage, according to the foregoing positional sequence, but is not limited thereby, it can be any other predetermined sequence. Moreover, the external charge and discharge voltages can be driven by using amplitude modulation (AM) of multi-level voltage, pulse-width modulation (PWM) of dual-level voltage, or by a grayscale voltage, but is not limited thereby.

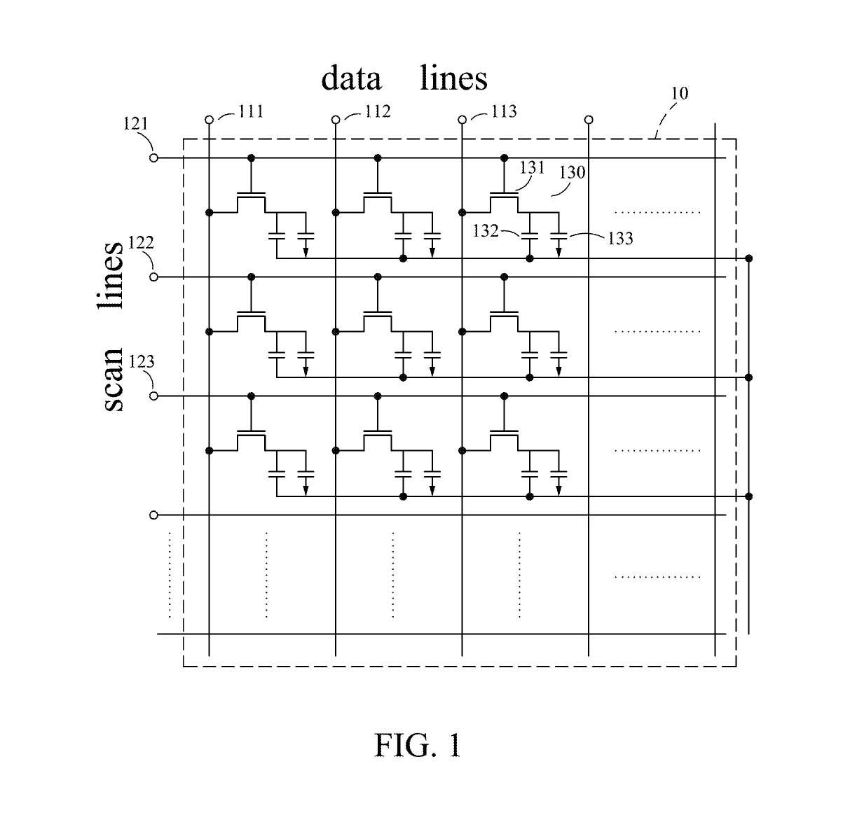

In FIGS. 1 and 3a, when a pixel 130 is charged by a charge voltage of V_{C}, capacitor voltage V_{LC} of the parasitic capacitor of chiral-nametic liquid crystal increases gradually toward v_{C}. However, capacitor voltage V_{LC} is modestly reduced due to leakage current in the parasitic capacitor. This causes a consideration of voltage holding ratio (VHR) for the pixel capacitor, which is a key factor in the LCD design. To improve the VHR of LCD, another driving voltage, the recharge voltage, is involved between the charge and discharge voltages in the same frame time in the embodiment. For example, if the recharge voltage is also provided with v_{C}, the potential of the capacitor voltage V_{LC} can be more recovered, as shown in FIG. 3b. Thus, the leakage of the parasitic capacitor can be compensated by involving the recharge voltage; consequently, the VHR of the LCD is improved. Also, the pixel 130 includes a storage capacitor 132 to facilitate the discharge driving.

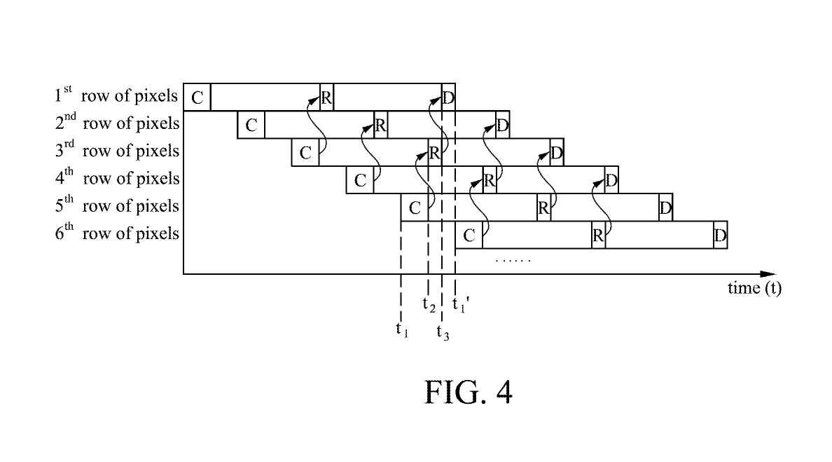

According to the present disclosure, a second embodiment provides another operating method for an active-matrix bistable chiral-nametic LCD. Please refer to FIG. 4, which is a timing diagram of the external driving voltages applied to the rows of pixels of the LCD. The driving voltages include the charge, recharge, and discharge voltages, respectively denoted as C, R, and D in FIG. 4. The operating method according the embodiment can refresh each frame of the LCD in a single frame time. The operational procedure includes: driving an external charge voltage V_{C} to a row of pixels of the LCD; removing the external charge voltage V_{C} from the row of pixels, and then the row of pixels being driven by an internal storage-capacitor voltage V_{SC} of the row of pixels in the following first time interval T₁; driving an external recharge voltage V_{R} to the row of pixels; removing the external recharge voltage V_{R} from the row of pixels, and then the row of pixels being driven by an internal storage-capacitor voltage V_{SC} of the row of pixels in the following second time interval T₂; and driving an external discharge voltage V_{D} to the row of pixels.

The operational schedule of the driving voltages among the rows of pixels is based on the concept of pipeline scheduling. A procedure of steps according to the following exemplary embodiment is illustrated in FIG. 4. At a time of t₁, the 5^{th} row of pixels is driven by the external charge voltage V_{C}. After a time interval of T_{C}, the external charge voltage V_{C} is removed from the 5^{th} row of pixels at the time of t₂≧t₁+T_{C}. At the same time, the 3^{rd} row of pixels is driven by the external recharge voltage V_{R}. After a time interval of T_{R}, the external recharge voltage V_{R} is removed from the 3^{rd} row of pixels at the time of t₃≧t₂+T_{R}. At the same time, the 1^{st} row of pixels is driven by the external discharge voltage V_{D}. After a time interval of T_{D}, the external discharge voltage V_{D} is removed from the 1^{st} row of pixels at the time of t₁′≧t₃+T_{D}. At the same time, the 6^{th} row of pixels is driven by the external charge voltage V_{C}. If t₂ can be arranged to be equal to t₁+T_{C}, t₃ can be arranged to be equal to t₂+T_{R}, and t₁′ can be arranged to be equal to t₃+T_{D}, the timing efficiency of the method may be maximized, but is not limited thereby. The foregoing steps are regarded as composition of a periodic cycle and repeated in the succeeding operation. Consequently, a single voltage source can provide various rows of pixels with driving the charge, recharge, and discharge voltage in various times of schedule. In the embodiment, the row of pixels is driven by an internal storage-capacitor voltage of the row of pixels after the external charge, recharge, or discharge voltage is removed. Further, durations of driving the external charge, recharge, and discharge voltage are the same in the embodiment, but are not limited thereby, they can be different from each other.

The foregoing example can be generalized as the following to represent the pipeline operation to drive various rows of pixels. At a time of t₁, the (n)^{th} row of pixels is driven by the external charge voltage V_{C}. After a time interval of T_{C}, the external charge voltage V_{C} is removed from the (n)^{th} row of pixels at the time of t₂=t₁+T_{C}. At the same time, the (n−2)^{th} row of pixels is driven by the external recharge voltage V_{R}. After a time interval of T_{R}, the external recharge voltage V_{R} is removed from the (n−2)^{th} row of pixels at the time of t₃=t₂+T_{R}. At the same time, the (n−4)^{th} row of pixels is driven by the external discharge voltage V_{D}. After a time interval of T_{D}, the external discharge voltage V_{D} is removed from the (n−4)^{th} row of pixels at the time of t₁′=t₃+T_{D}. At the same time, the (n+1)^{th} row of pixels is driven by the external charge voltage V_{C}. The foregoing steps can be regarded as composition of a periodic cycle and repeated in the succeeding operation. In this exemplary embodiment, various rows of pixels are driven, as charge, recharge, or discharge voltage, according to the foregoing positional sequence, but are not limited thereby, it can be any other predetermined sequence. Moreover, the external charge, recharge, and discharge voltages can be driven by using AM of multi-level voltage, PWM of dual-level voltage, or by a grayscale voltage, but is not limited thereby.

To increase image intensity and brightness of LCD panels, prior arts proposed to drive the chiral-nametic LC to the Homeotropic state in the charge stage of frame time, but the transient Homeotropic state poses the OFF state. The chiral-nametic LC is turned from the Homeotropic state to the Planar state after a discharge process. In the Planar state, the ON state of chiral-nametic LCs is completed. In the embodiments according to the present disclosure, however, the pipeline scheduling to drive pixels of the LCD proceeds the discharge process earlier to turn the chiral-nametic LC from the Homeotropic state to the Planar state, so as to improve the overall brightness of the LC panel.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An operating method for an active-matrix bistable liquid crystal display (LCD) in which each frame of the LCD is refreshed during a single frame time, the method comprising the steps of:
driving an external charge voltage to a row of pixels of the LCD;
removing the external charge voltage from the row of pixels, and then the row of pixels being driven by an internal storage-capacitor voltage of the row of pixels in the following first time interval; and
driving an external discharge voltage to the row of pixels.

2. The method of claim 1, wherein a sequence of external voltages driven to the row of pixels in a periodic cycle comprises the steps of:
driving the external charge voltage to a first row of pixels;
removing the external charge voltage from the first row of pixels;
driving an external discharge voltage to a second row of pixels after a second time interval; and
removing the external discharge voltage from the second row of pixels.

3. The method of claim 1, wherein durations of driving the external charge and discharge voltage are the same.

4. The method of claim 1, wherein durations of driving the external charge and discharge voltage are not the same.

5. The method of claim 2, wherein the external charge and discharge voltages are driven by using amplitude modulation (AM) of multi-level voltage.

6. The method of claim 2, wherein the external charge and discharge voltages are driven by using pulse-width modulation (PWM) of dual-level voltage.

7. The method of claim 2, wherein the external charge and discharge voltages are driven by a grayscale voltage.

8. The method of claim 2, wherein the first row of pixels is driven by an internal storage-capacitor voltage of the first row of pixels after the external charge voltage is removed, and the second row of pixels is driven by an internal storage-capacitor voltage of the second row of pixels after the external discharge voltage is removed.

9. An operating method for an active-matrix bistable LCD in which each frame of the LCD is refreshed during a single frame time, the method comprising the steps of:
driving an external charge voltage to a row of pixels of the LCD;
removing the external charge voltage from the row of pixels, and then the row of pixels being driven by an internal storage-capacitor voltage of the row of pixels in the following first time interval;
driving an external recharge voltage to the row of pixels;
removing the external recharge voltage from the row of pixels, and then the row of pixels being driven by an internal storage-capacitor voltage of the row of pixels in the following second time interval; and
driving an external discharge voltage to the row of pixels.

10. The method of claim 9, wherein durations of driving the external charge, recharge, and discharge voltage are the same.

11. The method of claim 9, wherein durations of driving the external charge, recharge, or discharge voltage are not the same.

12. The method of claim 9, further comprising: more than one steps of driving and then removing the external recharge voltage to the second row of pixels.

13. The method of claim 9, wherein a sequence of external voltages driven to the row of pixels in a periodic cycle comprises the steps of:
driving the external charge voltage to a first row of pixels;
removing the external charge voltage from the first row of pixels;
driving the external recharge voltage to a second row of pixels after a third time interval;
removing the external recharge voltage from the second row of pixels;
driving the external discharge voltage to a third row of pixels after a fourth time interval; and
removing the external discharge voltage from the third row of pixels.

14. The method of claim 13, wherein durations of driving the external charge, recharge, and discharge voltage are the same.

15. The method of claim 13, wherein durations of driving the external charge, recharge, or discharge voltage are not the same.

16. The method of claim 13, further comprising: more than one steps of driving and then removing the external recharge voltage to the second row of pixels.

17. The method of claim 13, wherein the external charge, recharge, and discharge voltages are driven by using AM of multi-level voltage.

18. The method of claim 13, wherein the external charge, recharge, and discharge voltages are driven by using PWM of dual-level voltage.

19. The method of claim 13, wherein the external charge, recharge, and discharge voltages are driven by a grayscale voltage.

20. The method of claim 13, wherein the first row of pixels is driven by an internal storage-capacitor voltage of the first row of pixels after the external charge voltage is removed, the second row of pixels is driven by an internal storage-capacitor voltage of the second row of pixels after the external recharge voltage is removed, and the third row of pixels is driven by an internal storage-capacitor voltage of the third row of pixels after the external discharge voltage is removed.
